(19) United States
(12) Patent Application Publication
(10) Pub. No.: US 2005/0046174 A1
(43) Pub. Date: Mar. 3, 2005

(54) Scrapbook Pocket

(76) Inventor: Michelle Botes, Rockaway, NJ (US)

Correspondence Address: MICHELLE BOTES, 66 LAKESHORE DR, ROCKAWAY, NJ, 07866, US

(21) Appl. No.: 10/904,248

(22) Filed: Oct. 31, 2004

(51) Int. Cl. B42F 5/00

(52) U.S. Cl. 281/45

(57) ABSTRACT

A scrapbook pocket is disclosed in one presently preferred embodiment as including first and second card stock sheets having at least one receiving pocket formed therebetween. Structurally, the scrapbook pocket preferably comprises an elongated body having at least two opposing sealed sides, an opening formed at the top of the receiving pocket, and a sealed end at the bottom of the scrapbook pocket.

### FIELD OF THE INVENTION

This invention relates to accessories for insertion and retention in flexible sheet protector in a loose-leaf binder or scrapbook which comprises a rigid paper sheet folded and bonded on two sides to form a pocket therein to provide a means for storing, holding mementos and keep-sakes, such as greeting cards, invitations, ticket stubs, and the like; the outsides of the said pocket can be used for adhering photos and scrapbook like items.

### BACKGROUND

Traditionally, scrapbook paper inserts of the prior art are typically comprised of one or more leafs of paper, paperboard, or the like which may comprise pictures and/or other memorabilia mounted thereon. This prior art did not provide a rigid and safe storage area for related extras such as greeting cards, invitations, ticket stubs, and the like.

### BRIEF SUMMARY AND OBJECTS OF THE INVENTION

In view of the foregoing, it is a primary object of the present invention to provide a ridged pocket for storage to be used as an insert in a scrapbook page protector. This ridged storage provides a safe area for the internal contents.

It is also an object of the present invention to provide an area for mounting pictures and/or other memorabilia thereon.

In addition, it is an object of the present invention to provide a scrapbook pocket which provides universal application for various applications.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 illustrates a front plan view of a first preferred embodiment of a Scrapbook pocket assembly in sheet form and an unfolded position;

FIG. 2 illustrates a front plan view of the scrapbook pocket assembly shown in FIG. 1, but in a folded position with a storage area within a pocket formed by the folded envelope assembly;

FIG. 3 illustrates a rear plan view of the scrapbook pocket assembly shown in FIGS. 1 and 2, in a folded position;

FIG. 4 is a front elevation view of a scrapbook pocket having memorabilia thereon and therein.

### DETAILED DESCRIPTION OF THE PREFERRED EMBODIMENTS

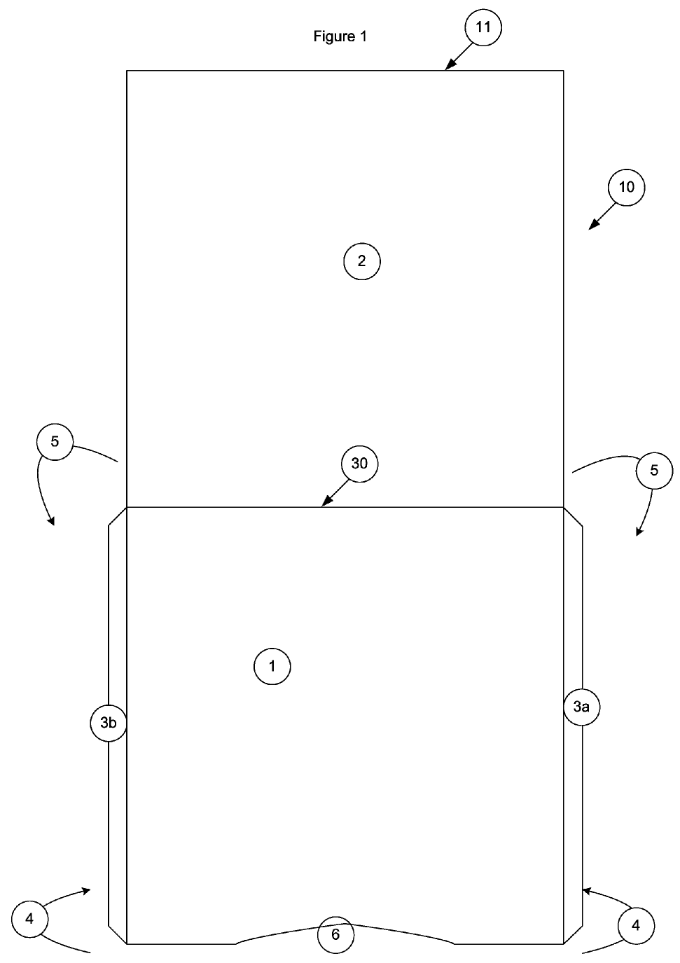

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1, 2, 3 and 4, is not intended to limit the scope of the invention, as claimed, but it is merely representative of the presently preferred embodiments of the invention.

The presently preferred embodiments of the invention will be best understood by reference to the drawings, wherein like parts are designated by like numerals throughout.

Referring now to the drawings, a Scrapbook Pocket according to the preferred embodiment of the present invention is designated generally by the numeral 10. The Scrapbook Pocket 10 is formed from a single sheet or continuous web of paper using an automated process generally well known to those skilled in the art. The Scrapbook Pocket 10 includes a front panel 1 that can have an optional scalloped edge 6, a bottom edge 30, and a pair of side edges 31 and 32.

The lengths of top and bottom edges 11 and 30 will be equal, and the lengths of the edges 31 and 32 will be equal.

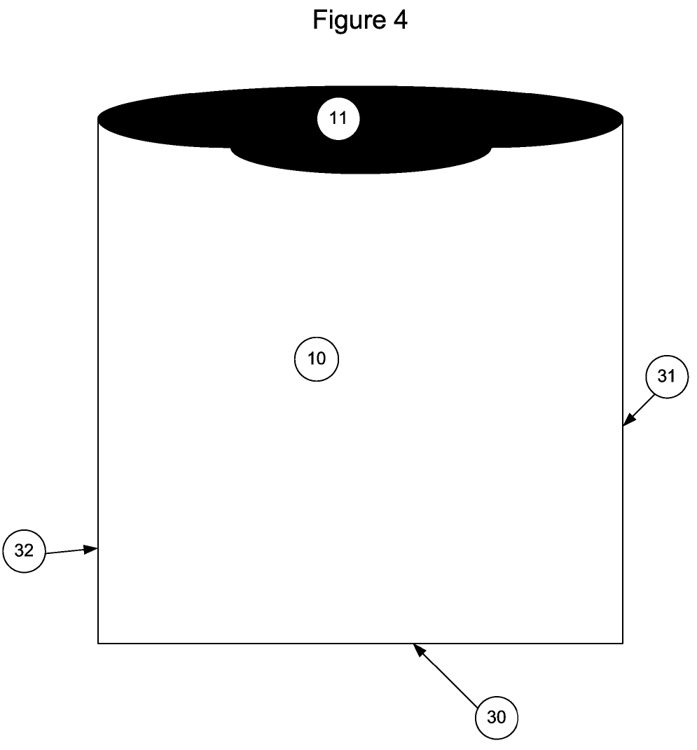

Front panel 1 has attached thereto along side edges 31 and 32 each a sealing flap 3a and 3b. Front panel 1 also has attached thereto along bottom edge 30 the rear panel 2. Flap 3a and 3b will folded inward, as depicted in 4. Front panel 1 and back panel 2 will be folded towards each other 5. Flap 3a and 3b is adhered to the inside of the back panel 2 to form a pocket as depicted in FIG. 1. The pocket will be closed on edges 31, 32 and 30 with an opening 11 at the top as depicted in FIG. 4.

Finally, front panel 1 has an optional scalloped edge 6. This scalloped edge can serve the purpose of easing the access to the pocked formed between the front panel 1 and the rear panel 2 as depicted in FIG. 4.

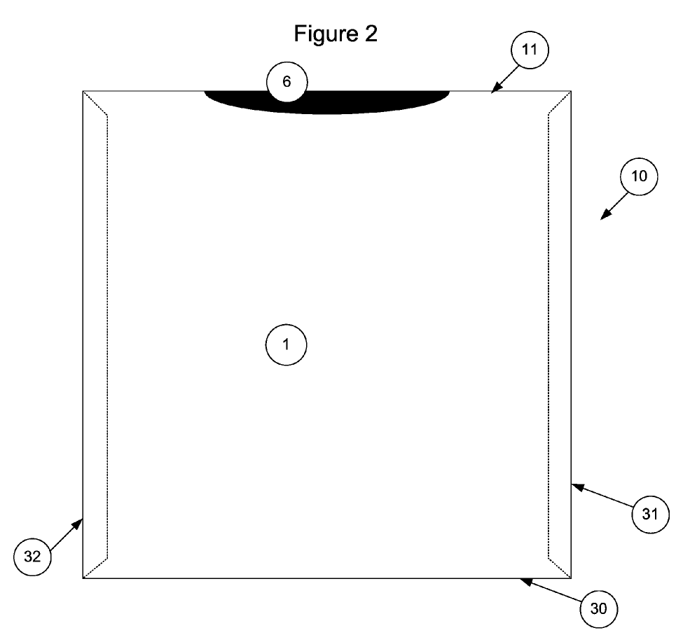

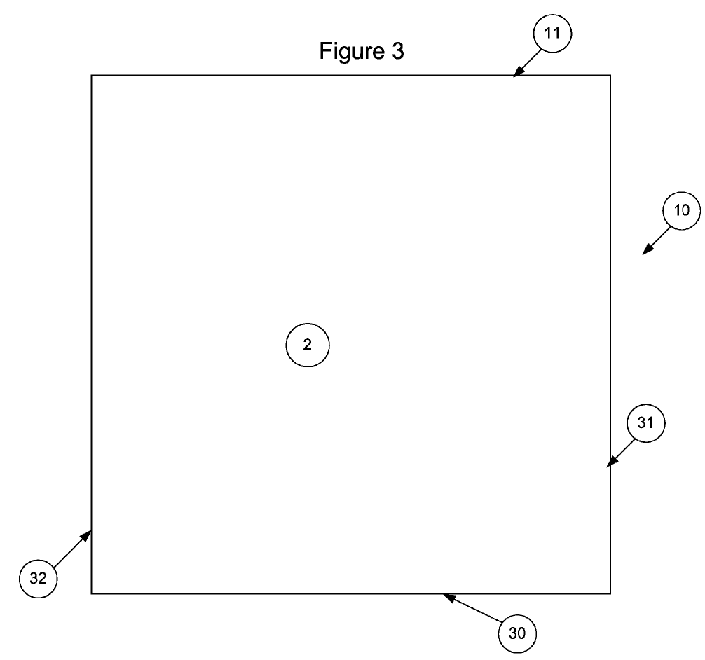

Referring now to FIG. 2 and FIG. 3, there is shown a completed Scrapbook Pocket 10 ready for use.

From the foregoing, it may be seen that the present invention is well suited to achieving the objects of the present invention. The present invention has been illustrated and described with respect to a presently preferred embodiment. Accordingly, the foregoing is intended for purposes of illustration rather than limitation. Those skilled in the art will recognize alternative embodiments, given the benefit of this disclosure. For example, alternative materials and sizes may be used, and alternative panel and flap arrangements may be employed, as all would be apparent to one skilled in the art, given the benefit of the foregoing description.

1. A scrapbook pocket, comprising:
a front panel, said front panel having a four pairs edges;
a pair of side flaps attached to the side edges of the front panel, said flaps being folded over said side edges, each of said side flaps being of equal width;
a back flap attached to the front edge, said back flap being folded over said side and adhered to said side flaps;
a receiving portion which is configured so as to be capable of selectively receiving contents.

2. The Scrapbook Pocket as claimed in claim 1, wherein said back flap is adhered to said side flaps.

3. A Scrapbook Pocket, which comprises:
a rectangular front panel, said front panel having two pairs of parallel edges;
the said forming a pocket with three sides enclosed;
the said with on side forming an opening to receive memorabilia;
the front panel to receive embellishments and memorabilia;
the rear panel to receive embellishments and memorabilia.
